(19) United States
(12) Patent Application Publication
(10) Pub. No.: US 2023/0391527 A1
(43) Pub. Date: Dec. 7, 2023

(54) Environmentally Friendly Blister Package With Contact Adhesive

(71) Applicant: henkel AG & CO., KGaA, Dusseldorf (DE)

(72) Inventor: Winston S. Foo, Bridgewater, NJ (US)

(21) Appl. No.: 18/454,213

(22) Filed: Aug. 23, 2023

Related U.S. Application Data
(63) Continuation of application No. PCT/US22/18244, filed on Mar. 1, 2022.
(60) Provisional application No. 63/156,018, filed on Mar. 3, 2021.

(51) Int. Cl. B65D 75/32; B65D 65/38

(52) U.S. Cl. CPC B65D 75/326; B65D 65/38; B65D 2565/385; B65D 2575/3209

(57) ABSTRACT

The present invention provides environmentally friendly blister package and method of forming the blister package for odd-shaped goods with contact adhesives. The blister package is formed from recyclable or renewable substrates. The contact adhesives form strong cohesive bonds with each other with minimal adhesion to all other surfaces, including the goods packaged therewith.

### FIELD OF THE INVENTION

The invention is related to environmentally friendly blister package and method of forming the blister package with contact adhesives, and this is particularly useful packaging odd-shaped goods.

### BACKGROUND OF THE INVENTION

Storing and packaging odd-shaped goods, including rounded goods or odd-shaped goods, are difficult since they are challenging to store and can roll off flat surface during packaging. Also, odd-shaped packages can be damaged themselves or damage other goods in the container during transport.

The odd-shaped goods are often wrapped or packaged in a rectangular container for storage, transport, and shelf-placement (at a store). For example, a ball is packaged in a square or rectangular container for ease of storage and transport. Or the odd-shaped good is packaged such that it has at least one flat surface for packaging and display.

Many odd-shaped consumer goods, foods, and pharmaceutical items are packaged in blister package or blister pack. A typical blister package secures this good between a paperboard and a thermoformed plastic part. The transparent thermoformed plastic parts are made of pre-formed plastics such as polyvinyl chloride (PVC), polyvinylidene chloride (PVDC), polychlorotrifluoroethylene (PCTFE), cyclic olefin copolymer (COC) from polypropylene (PP) or polyethylene(PE), glycol-modified polyethylene terephthalate (PET), which can end up in landfill. High heat and pressure are required to adhere the plastic part to the paper substrate, which has a high environmental cost.

Accordingly, there is a need in the art environmentally friendly method of packaging odd-shaped goods. The current invention fulfills this need.

### BRIEF SUMMARY OF THE INVENTION

The invention provides an environmentally friendly package and method of forming an environmentally friendly package for odd-shaped goods. Importantly, the package is formed so that the contact adhesive does not leave any residue on the goods.

One aspect of the invention is directed to an environmentally friendly package comprising (a) a paperboard substrate having a contact adhesive on one surface; (b) a paper substrate having the same contact adhesive on one surface; (c) an article, wherein the article is secured in between the paperboard substrate and the paper substrate and the contact adhesive of the paperboard substrate is adhered onto the contact adhesive of the paper substrate.

Another aspect of the invention is directed to an environmentally friendly package comprising (a) a paperboard substrate having a pre-applied contact adhesive on one surface; (b) a paper substrate having the same contact adhesive pre-applied on one surface; (c) an article, wherein the article is in between the paperboard substrate and the paper substrate, and wherein the pre-applied contact adhesive of the paperboard substrate is adhered onto the pre-applied contact adhesive of the paper substrate.

The contact adhesive comprises (a) a metallocene-catalyzed olefin block copolymer, (b) a mixture of polyethylene wax and Fischer-Tropsch wax having a penetration hardness value of less than about 5 dmm at 25° C., measured in accordance with ASTM D3954, (c) a plasticizer, (d) a tackifier.

Yet in another aspect of the invention is directed to a method of forming environmentally friendly package comprising:
(1) preparing a paperboard substrate having a first surface and a second surface;
(2) applying a contact adhesive onto the first surface of the paperboard substrate;
(3) preparing a paper substrate having a first surface and a second surface;
(4) applying a contact adhesive onto the second surface of the paper substrate;
(5) placing an article onto the first surface of the paperboard; and
(6) securing the article by applying the second surface of the paper surface on the first surface of the paperboard;
whereby the applied contact adhesive of the paperboard and the applied contact adhesive of the paper are joined together around the article.

In another aspect, the contact adhesive is pre-applied on the first surface of the paperboard substrate and the same contact adhesive is pre-applied on the second surface of the paper substrate. The article is placed atop of the pre-applied contact adhesive surface of the paperboard substrate and the pre-applied contact adhesive surface of the paper substrate is place atop of the article and joins the two substrates together by pressure. The pre-applied contact adhesive surfaces bond from the pressure and secures the article in place.

These and other aspects of the invention are described in the description below. In no event should the above summary be construed as a limitation on the claimed subject matter which is defined solely by the claimed as set forth herein.

### BRIEF DESCRIPTION OF THE DRAWING

FIG. 1A is a schematic drawing of the environmentally friendly blister pack.

FIG. 1B is a schematic drawing of the packaged environmentally friendly blister pack.

FIG. 2A is a photograph of the packaged environmentally friendly blister pack.

FIG. 2B a is a photograph of the packaged environmentally friendly blister pack with minimal paper substrate.

FIG. 3 is a representation of the 1″×1″ overlap and 3″ of each substrate overhang.

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

As used herein, the term “cohesive bond,” “cohesion” and “cohesiveness,” interchangeably used, is the internal strength of an adhesive as a result of a variety of interactions within the adhesive.

As used herein, the term, “adhesive bond,” “adhesion” and “adhesiveness,” interchangeably used, is the bonding of one material to another, namely an adhesive to a substrate, due to a variety of possible interactions.

As used herein blocking is adhesion between the contact adhesive and a touching layer, e.g., substrate, under moderate pressure during storage or use, typically described and measured by ASTM D 907-06.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

The present invention provides forming an environmentally friendly blister package or blister pack. In a preferred embodiment, the contact adhesive is pre-applied to both substrates and a good is secured in between the substrates by applying the contact adhesives to each other. The contact adhesives only forms adhesion onto itself, and as such, no adhesion onto other substrates, including the good, is realized. This minimizes time, cost, and equipment, particularly heat-sealing tools typically used to minimize the thermoformed plastic part of a blister pack.

Securing the good in between the substrates with the contact adhesive has several advantages. Rapid processing is possible. The contact adhesive can be pre-applied onto a substrate. Because the pre-applied contact adhesive has minimal to almost no tack the substrates can be stacked immediately after application without a concern for adhesion onto other substrates. The pre-applied contact adhesive does not create tack, and dirt and dust do not adhere onto the contact adhesive.

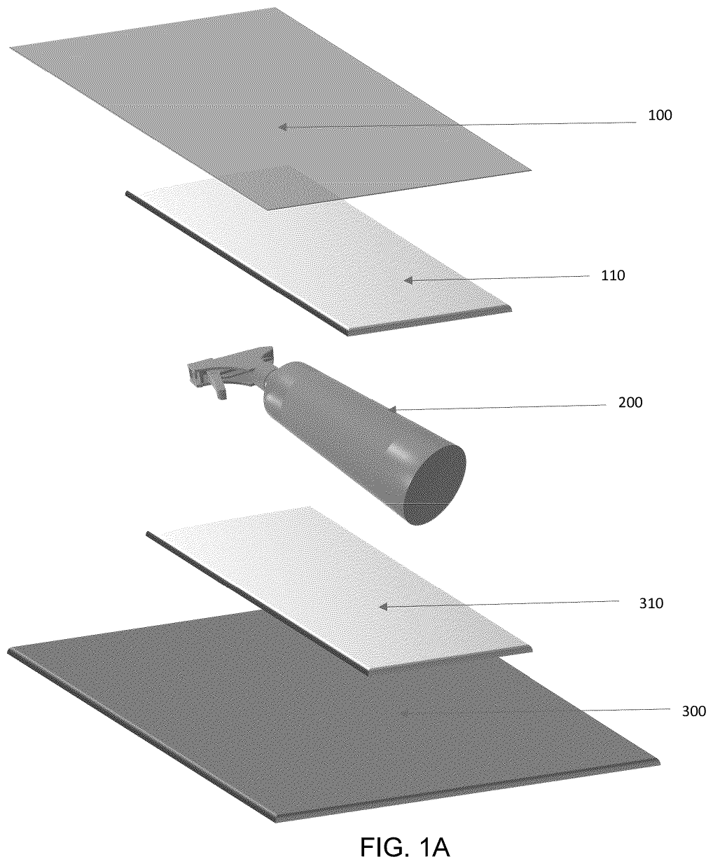

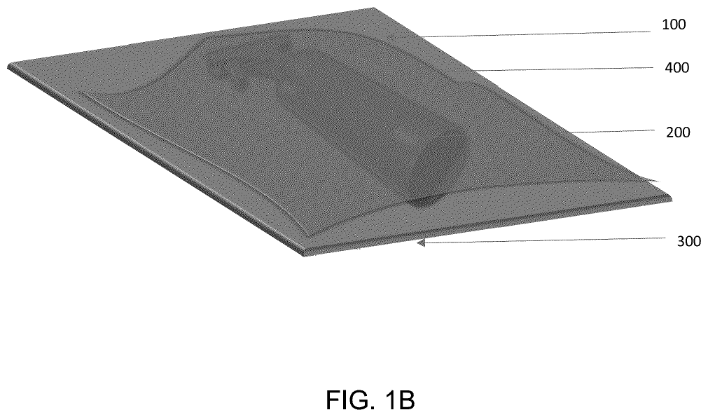

In FIG. 1, paper substrate 100 has two surfaces and one surface, facing the article of good, is coated with contact adhesive 110. The contact adhesive may be pre-applied. A paperboard substrate 300 has two surfaces and one surface, facing the article of good, is coated with contact adhesive 310. Again, the contact adhesive may be pre-applied. An article of good 200 is secured in between the two contact adhesives.

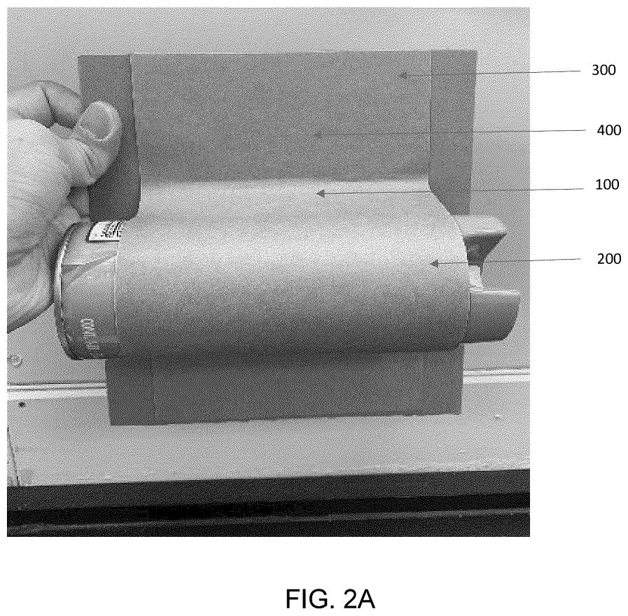

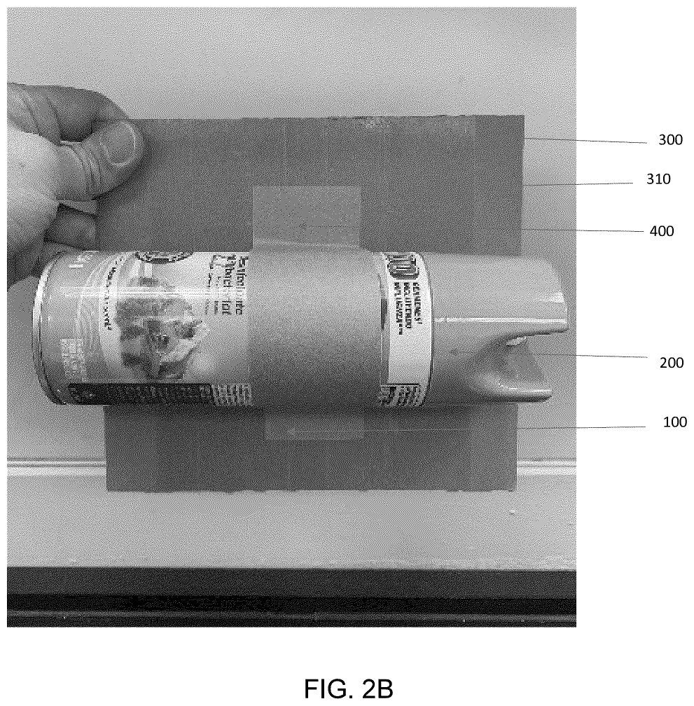

FIG. 2 shows a packaged, where the article of good 200 is secured in between the paperboard board 300 and paper substrate 100. Only the areas 400 where the contact adhesive touches each other realizes adhesion. On the area where only one surface has the contact adhesive or where the contact adhesives do not touch each other, there is no adhesion. There is no adhesion to the surrounding area around the good where the paper and paper boards to not touch each other. The good is secured and is immobile but no adhesion or tack is realized on the good from the contact adhesive.

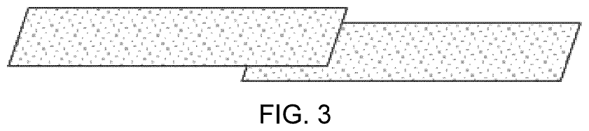

FIG. 3 is a photograph of a blister package. The article 200 is cylindrical in shape and is secured in between a paper substrate 100 and a paperboard substrate 300. The article is secured by mating the area 400 of contact adhesive from the paperboard substate and the paper substate.

FIG. 4 is a photograph of a blister package with exposed contact adhesive 310. The paperboard substrate 300 contains a pre-applied contact adhesive 310. The paper substrate 100 is mated onto the paperboard with the same contact adhesive. The area 400 where the two contact adhesives mate has adhesion and secures the cylindrical article 200.

The article of good is less likely to roll during packaging and during shipping in the boxed container or envelop. As shown in the FIGS. 2A and 2B, the paper substrate and paperboard substrate can be chosen in various shapes and sizes to minimize the environmental impact, and yet appropriately sized to secure the article of good.

The paperboard substrate provides rigidity to the packaged article. It provides a flat surface for the packaged article to be placed on a horizontal surface or against a container or envelope. The paperboard substrate may be formed from boxboard such as folding boxboard, chipboard or Kraft board. These paperboard substrates are made from thick paper stock or heavy paper pulp, having a thickness of about 0.18″ (18 pt) or greater. The paperboard substrate may also be formed from containerboard such as corrugated boards with medium or linerboard without the medium. The corrugated boards may be single wall board, double wall board or triple wall board, with A, B, C, E or F flutes. The thickness and the size of the paperboard substrate can be selected by a skilled artisan depending on the weight and shape of the goods to be secured.

The paper substrate is thinner than the paperboard substrate. While the paperboard substrate provides stability, this thinner paper substrate can conform better to the shape of the article, and hold to the paperboard substrate with the contact adhesive. Preferably, the paper substrate is a Kraft paper. The paper substrate preferably has a thickness of about 0.008″ (8 point) to about 0.024″ (24 point). The thickness and the size of the paper substrate can also be selected by a skilled artisan depending on the weight and shape of the article of good. Size, shape and weight of the paper substrate and paperboard substrate can be varied to secure the good. It is also envisioned that the paper substrates may not envelop the entire surface of the good, as shown in FIG. 2B. In fact, multiple strips of paper substrates may be utilized to secure the article of goods to minimize environmental impact.

It is envisioned that other substrates may be used to bond with the paperboard substrate. Thermoformable plastic substrates may be combined with the paper substrates to bond to the paperboard substrates; however, any such thermoformable plastic substrates should be minimized for environmentally friendly packages. In addition, foil, metallized paper or coated paper that has water barrier or water resistance may also be combined with paper substrates to form the blister pack. Again, high energy intensive material should be minimized for environmentally friendly packages.

The blister package is adhered with a contact adhesive. The contact adhesive provides tacky properties only to itself, and does not bond to any other substrates, including the article of goods. A bond can be formed with only a hand pressure and no additional forms of activation (water, light, heat, radiation, machine pressure is required.

Both paperboard substrates and paper substrates with pre-applied contact adhesive provide flexibility since they can be stacked for storage and transportation, or they can be further processed in machinery and assembly without affecting the contact adhesive bonds. So long as the contact adhesive does not come in contact with another contact adhesive, they can remain unactivated and non-tacky. In addition, the inventive contact adhesive can also be pre-applied to plastic film, metal, and metalize paper. Paper substrates can be bonded to the plastic film, metal, and metalized paper by mating the same contact adhesive.

In one embodiment, the contact adhesive comprises an olefin block copolymer, a tackifier, a plasticizer, and a wax. Another embodiment is directed to a layer of contact adhesive comprising an olefin block copolymer, a tackifier, a plasticizer, and a wax, wherein the layer has a thickness from about 2 to about 150 g/m 2, and the surface of the contact adhesive layer is non-tacky.

The term “olefin block copolymer” or “OBC” is an ethylene/alpha-olefin multi-block copolymer and includes ethylene and one or more copolymerizable alpha-olefin comonomer in polymerized form, characterized by multiple blocks or segments of two or more polymerized monomer units differing in chemical or physical properties. In some embodiments, the multi-block copolymer can be represented by the following formula:

(AB)n

where n is at least 1, preferably an integer greater than 1, such as 2, 3, 4, 5, 10, 15, 20, 30, 40, 50, 60, 70, 80, 90, 100, or higher, “A” represents a hard block or segment and “B” represents a soft block or segment. Preferably, As and Bs are linked in a substantially linear fashion, as opposed to a substantially branched or substantially star-shaped fashion. In other embodiments, A blocks and B blocks are randomly distributed along the polymer chain. In other words, the block copolymers usually do not have a structure as follows.

AAA-AA-BBB-BB

In still other embodiments, the block copolymers do not usually have a third type of block, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

Preferably, ethylene comprises the majority mole fraction of the whole block copolymer, i.e., ethylene comprises at least 50 mole percent of the whole polymer. More preferably ethylene comprises at least 60 mole percent, at least 70 mole percent, or at least 80 mole percent, with the substantial remainder of the whole polymer comprising at least one other comonomer that is preferably an alpha-olefin having 3 or more carbon atoms. For many ethylene/octene block copolymers, the preferred composition comprises an ethylene content greater than 80 mole percent of the whole polymer and an octene content of from 10 to 15, preferably from 15 to 20 mole percent of the whole polymer.

The olefin block copolymer includes various amounts of “hard” and “soft” segments, “Hard” segments are blocks of polymerized units in which ethylene is present in an amount of 92 mol % to 99 mol %, 96 mol % to 98 mol % or 95 mol % to 98 mol %. In other words, the comonomer content (content of monomers other than ethylene) in the hard segments is 1 mol % to 8 mol %, 2 mol % to 5 mol % or 2 mol % to 4 mol %. “Soft” segments are blocks of polymerized units in which the comonomer content (content of monomers other than ethylene) is 10 mol % to 15 mol %, 10 mol % to 13 mol % or 11 mol % to 12 mol %. In other words, the ethylene content is 85 mol % to 90 mol %, 86 mol % to 89 mol % or 87 mol % to 88 mol %. A difference of at least one half mole percent is statistically significant. The hard segments can be present in the OBC in amounts of 20 wt %-45 wt %, preferably 25 wt % to 40 wt %, more preferably 30 wt % to 40 wt % by weight of the block copolymer, with soft segments comprising the remainder. The soft segment weight percentage and the hard segment weight percentage can be calculated based on data obtained from DSC or NMR, and mole percentages calculated therefrom. Such methods and calculations are disclosed in, for example, U.S. Pat. No. 7,608,668, entitled “Ethylene alpha-Olefin Block Interpolymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in Column 57 to Column 63 of U.S. Pat. No. 7,608,668.

The olefin block copolymer is a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present OBC is characterized by unique distributions of both polymer polydispersity (PDI or Mw/Mn or MWD), block length distribution, and/or block number distribution, due, in an embodiment, to the effect of the shuttling agent(s) in combination with multiple catalysts used in their preparation.

In an embodiment, the OBC is produced in a continuous process and possesses a polydispersity index, PDI, from 1.7 to 3.5, or from 1.8 to 3, or from 1.8 to 2.5, or from 1.8 to 2.2. When produced in a batch or semi-batch process, the OBC possesses PDI from 1.0 to 3.5, or from 1.3 to 3, or from 1.4 to 2.5, or from 1.4 to 2.

In addition, the olefin block copolymer possesses a PDI fitting a Schultz-Flory distribution rather than a Poisson distribution. The present OBC has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phvs. (1997) 107 (21), pp 9234-9238.

In an embodiment, the present olefin block copolymer possesses a most probable distribution of block lengths.

In an embodiment, the olefin block copolymer is defined as having:
(A) a molecular fraction which elutes between 40° C. and 130° C. when fractionated using TREF, characterized in that the fraction has a block index of at least 0.5 and up to 1 and a molecular weight distribution, Mw/Mn, greater than 1.3; and/or
(B) average block index greater than zero and up to 1.0 and a molecular weight distribution, Mw/Mn greater than 1.3. Block Index can be determined as described in detail in U.S. Pat. No. 7,608,668 herein incorporated by reference for that purpose. Analytical methods for determining properties (A) through (B) are disclosed in, for example, U.S. Pat. No. 7,608,668, Cot 31, line 26 through Cot 35, line 44, which is herein incorporated by reference for that purpose.

Suitable monomers for use in preparing the present OBC include ethylene and one or more addition polymerizable monomers other than ethylene. Examples of suitable comonomers include straight-chain or branched alpha-olefins of 3 to 30, preferably 3 to 20, carbon atoms, such as propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene; cyclo-olefins of 3 to 30, preferably 3 to 20, carbon atoms, such as cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene; di- and polyolefins, such as butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidenenorbornene, vinyl norbornene, dicyclopentadiene, 7-methyl-1,6-octadiene, 4-ethylidene-8-methyl-1,7-nonadiene, and and 3-phenylpropene, 4-phenylpropene, 1,2-difluoroethylene, tetrafluoroethylene, and 3,3,3-trifluoro-1-propene.

The olefin block copolymer has a density of from 0,850 g/cc to 0.880 g/cc, or from 0.850 g/cc to 0879 g/cc. In an embodiment, the olefin block copolymer has a melt index (Ml) from 5 g/10 min to 1000 g/10 min, or from 15 g/10 min to 50 g/10 min, or from g/10 min to 40 g/10 min, as measured by ASTM D 1238 (190° C./2.16 kg). The olefin block copolymer is present in an amount of 10 wt % to 45 wt %, preferably 15 wt % to wt %, more preferably 20 wt % to 35 wt %, based on total weight of formulation. The olefin block copolymer has an Mw of 15,000 to 100,000 g/mol or preferably of 20,000 to 75,000. The olefin block copolymer has a Tm as measured by DSC of 60° C. to 115° C., of to 110° C., or of 90° C. to 105° C. The olefin block copolymer also has a Tc as measured by DSC of 45° C. to 100° C., of 60° C. to 90° C. or of 70° C. to 80° C. In some embodiments, the total crystallinity of the olefin block copolymers is 5 wt %-30 wt %, preferably 10 wt % to 25 wt %, more preferably 15 wt % to 20 wt %. The olefin block copolymers are produced via a chain shuttling process such as described in U.S. Pat. No. 7,858,706, which is herein incorporated by reference. In particular, suitable chain shuttling agents and related information are listed in Col. 16, line 39 through Col. 19, line 44. Suitable catalysts are described in Col. 19, line 45 through Col. 46, line 19 and suitable co-catalysts in Col. 46, line 20 through Col. 51 line 28. The process is described throughout the document, but particularly in Col. Col 51, line 29 through Col. 54, line 56. The process is also described, for example, in the following: U.S. Pat. Nos. 7,608,668; 7,893,166; and 7,947,793 as well as US Patent Application Publication No. 20100197880.

Olefin block copolymers differ from olefin random copolymer or interpolymers. The ethylene/alpha olefin copolymer comprises a first homogeneously branched random ethylene/alpha-olefin copolymer and a second homogeneously branched random ethylene/alpha-olefin copolymer. “Random copolymer” or ‘interpolymer” means a copolymer wherein the at least two different monomers are arranged in a non-uniform order. The term “random copolymer” and “interpolymer” specifically excludes block, OBC, copolymers. The term “homogeneous ethylene polymer” as used to describe ethylene polymers is used in the conventional sense in accordance with the original disclosure by Elston in U.S. Pat. No. 3,645,992, the disclosure of which is incorporated herein by reference, to refer to an ethylene polymer in which the comonomer is randomly distributed within a given polymer molecule and wherein substantially all of the polymer molecules have substantially the same ethylene to comonomer molar ratio.

It is important for the contact adhesive to essentially be free of any polypropylene based polymer or waxes. Typical polymers have a weight average molecular weight (Mw) of greater than about 10,000 Daltons, and typical waxes have a Mw of less than about 10,000 Daltons. Without being bound to any specific theory, the addition of a polypropylene based polymer in a contact adhesive provides crystallization, and this decreases tack over a prolonged time.

In another embodiment, the contact adhesive is essentially free from other polymers, having a weight average molecular weight of greater than 10,000 Daltons, which decreases tack and/or increases viscosity at application temperature.

The contact adhesive also comprises a mixture of soft waxes. The wax mixture is a combination of soft polyethylene waxes and soft Fischer-Tropsch waxes. The wax, individually and as a mixture, has a penetration hardness value of less than or equal to about 5 dmm, preferably less than or equal to about 4 dmm, and most preferably less than or equal to about 3 dmm at 25° C., measured in accordance with ASTM D1321.

The drop point (measured according to ASTM D 3954) of the wax, individually or as a mixture, is from about 60 to 160° C., preferably from about 80 to 120° C. The weight average (Mw) molecular weight of the wax, individually or as a mixture, ranges from about 200 to about 7000 Daltons. Wax is added at a levels of about 0.5 to about 15 wt % based on the total weight of the adhesive.

A plasticizer is also added to the contact adhesive. Suitable plasticizers include esters or polyoxyalkylene, and medicinal white oils, naphthenic, aliphatic or aromatic mineral oils, polypropylene, polybutene, polyisoprene oligomers, hydrogenated polyisoprene and/or polybutadiene oligomers are particularly suitable. Hydrogenated plasticizers are for example selected from the group of paraffinic hydrocarbon oils. In particular, white oils, mineral oils, polyisobutylene and hydrogenated hydrocarbons are suitable. Plasticizers having a molecular weight of about 200 to 5000 g/mol are preferred. The plasticizers with a boiling point above 200° C. is preferred to maintain stable storage for a prolonged time. The amount of the plasticizer should be up to 15 wt %, in particular, from about 3 to about 10%.

The contact adhesive further comprises a tackifying resin. The tackifying resin increases the adhesion and improves the miscibility and compatibility of the various components in the adhesive. It is generally used in an amount of from about 20 to about 70 wt %, in particular from about 25 to about 60 wt %, based on the total weight of the adhesive.

Suitable tackifying resin include aromatic, aliphatic or cycloaliphatic hydrocarbon resins and modified or hydrogenated natural resins. Examples include terpene resins, such as copolymers of terpene; modified natural resins such as resin acids from gum rosin, tall oil rosin or rosin, optionally also hydrocarbyl and its esters; acrylic acid copolymers such as styrene-acrylic acid copolymers or copolymers of ethylene, acrylate esters, and maleic anhydride; or resins based on functional hydrocarbon resins. As a tackifier resin, low molecular weight reaction products are suitable which consist of the ethylene/propylene-α-olefin polymers mentioned above. The molecular weight of such as a resin of suitable olefin polymers is usually below 2000 g/mol, and has a softening point of 80 to 140° C. (ASTM method E28). Particularly preferred resins are fully or partially hydrogenated hydrocarbon resins or natural resins based on rosin and tall oil rosin.

The contact adhesive comprises optional components including stabilizers, coupling agents, antioxidants, fillers and/or pigments or other polymers. The amount of the additives is in the range of about 001 to about 30 wt %.

The contact adhesive of the invention is prepared by known methods, by mixing in the melt. In this case, all components can be presented simultaneously heated and then homogenized, or easily melted components will be first submitted to and mixed, then the further resin components. It is also possible to continuously produce the contact adhesive in an extruder.

The contact adhesive has a viscosity of 500 to 20,000 m Pas, preferably from 300 to 10,000, measured at 165.6° C. (330° F.) (Brookfield, EN ISO 2555, measured at the temperature indicated).

The thickness of the applied contact adhesive, is for example from about 2 to about 150 microns (2 to 150 g/m²). In particular, the contact adhesive thickness should be less than 75 microns. The adhesive may be applied in a molten state at about 250 to about 350° F. to a given substrate and upon cooling, the contact adhesive is no longer tacky. The substrates with the applied contact adhesive may then be stored in this non-blocky (non-tacky) form.

The contact adhesive of the invention balances the adhesiveness to substrates upon application, maintains cohesive properties and remain non-blocky throughout the transportation and storage phase, and maintains strong cohesive strength even after aging conditions to fully bond substrates together.

In this state, the contact adhesive layer is to be stored without losing its cohesive characteristics. A bond is achieved later by pressing against another substrate having the same contact adhesive. For bonding, the coated substrate with the contact adhesive layer, according to the invention, is pressed with a second substrate against each other, this must also have a corresponding contact adhesive layer on the body to be bonded. Pressing may be done with light pressure, for example, by hand.

The adhesive maintains a bond strength during storage and transportation. As the surface area of the bound area of the paperboard and paper increase, the bond strength also increases. To minimize carbon footprint, minimal substrates should be used to form the blister pack. The contact adhesive of the invention can maintain a bond strength of greater than 7, 8, 9, or 10 pound-force per inch (lb·f/in) based on 1″×1″ square area that has been coated with about 1 mil to about 1.5 mil, particularly on paperboard substrate and paper substrate. This immediate shear strength formed with mere hand pressure to bond the paperboard substrate with paper substrate yields of at least about 10 lb·f/in, preferably at least about 11, 12, 13, 14 or 15 lb·f/in. The strength of the contact adhesive and the minimal amount of substrates provide an environmentally friendly blister pack. As packaged, the blister pack shifts less during transport and can minimize damage to the pack and/or other contents in the same container. Additional cushioning materials can be minimized in the container to decrease damage during transport for the blister pack.

Additionally, unwrapping or removing the paper substate or paperboard substrate from the blister pack by the consumer can be easily performed since the shear strength is less than about 30, 25 or 20 lb·f in. The paperboard and paper can be recycled to minimize waste.

The coated substrates with the instant contact adhesives are storable. It is possible to stack the substrates with the instant contact adhesive immediately after production and cooling. It is important to ensure that the contact adhesive layers of the invention are not supported against each other, but against other substrate layers without the contact adhesive. Since the contact adhesive layer of the invention is not tacky, sticking and blocking of stacked substrates from the contact adhesive is not observed. In a subsequent use, they can be easily separated from each other. The non-sticky, pre-space-saving storage is possible since the substrate is easily separated from the contact adhesive.

### EXAMPLES

Table I describes the components of the inventive contact adhesive (Example.) The components were homogenized under heat. The contact adhesive was clear white upon homogenization.

TABLE I
Example 1 Contact Adhesive

| Components | Wt % |
|---|---|
| Olefin block copolymer | 18 |
| Polyethylene wax (hardness = 3) | 14 |
| Polyethylene was (hardness < 1) | 4 |
| Fischer-Tropsch wax (hardness = 1) | 3 |
| LDPE 955I* from Dow Chemical | |
| Hydrocarbon Resin | 47 |
| Liquid Polybutene | 13.5 |
| Anti-oxidant | 0.5 |

To determine the blocking resistance of contact adhesive to coated substrates, a thickness of 1.5 mil of Example 1 contact adhesive was applied onto a Kraft paper and cooled. A second, non-coated Kraft paper was placed atop of the cooled adhesive and a 1 kg weight was placed atop of the stack. This was placed in a chamber of 84% relative humidity and 72° F. storage for 72 hours. At the end of the 72 hours, the non-coated Kraft paper was separated by hand from the adhesive coated Kraft paper and the former was examined to determine whether the adhesive developed adhesion to the second, non-coated Kraft paper. Only fiber pick up was observed on the second non-coated Kraft paper for Example, indicating only contaminates of fiber was visible on the adhesive, and the contact adhesive was non-blocking.

The Example 1 contact adhesive was applied onto a Kraft paper at 330° F. and then the apparatus was cooled. Blocking resistance test was conducted by placing a second, non-coated Kraft paper atop of the cooled adhesive and a 1 kg weight was placed atop of the stack. For the blocking at 140° F., fiber pick-up was observed on the second non-coated Kraft paper which means only contaminates of fiber was visible on the adhesive. In addition, there was no oil stain on the non-coated Kraft paper. The coated adhesives of the Example sample were then pressed onto each other with a 2.3 Kg roller press. The substrates were then pulled apart and percent average fiber tear was 92%.

TABLE 2

| | |
|---|---|
| Blocking test | No fiber pick-up |
| 0° F., 72 h, 1 kg Weight | |
| Blocking test | No fiber pick-up |
| room temperature, 72 h, 1 kg Weight | |
| Blocking test | fiber pick-up |
| 140° F., 72 h, 1 kg Weight | no oil stain |
| Cohesion test after blocking test at 140° F. | 92 |
| % Average fiber tear | |

An apparatus was made by using a 1″×4″ Kraft paper substrate (Substrate A) and a 1″×4″ corrugated paperboard substrate (Substrate B). Example 1 contact adhesive was applied at one end, in an area 1″×1″, of Substrate B at 300-320° F. with either 1 mil or 1.5 mil to 1″×1″ of Substrate A so that an overlap of 1″×1″ bond and 3″ of each substrate overhanging, as represented in FIG. 3.

The apparatus was left at room temperature for 24 hours. A masking tape was applied at both ends of the apparatus (the non-bonded end), having a size of about 1″. Each masking tape ends was secured to the Sintech/Instron, and each end was pulled at 180° angle at 1 inch per minute to measure the shear strength of the bond. On the average, the shear adhesion of the 1″×1″ samples ranged from about 13 to about 19 lb·f/in.

TABLE 3

| Sample # | Substrate A | Substrate B | lb · f/in² |
|---|---|---|---|
| 1 | 1.5 mil | 1.5 mil | 14.01 |
| 2 | 1.5 mil | 1.5 mil | 13.22 |
| 3 | 1.5 mil | 1.5 mil | 15.49 |
| 4 | 1.5 mil | 1.5 mil | 14.35 |
| 5 | 1.5 mil | 1.5 mil | 18.17 |
| ave 1-5 | | | 15.05 |
| 6 | 1.0 mil | 1.5 mil | 15.70 |
| 7 | 1.0 mil | 1.5 mil | 15.63 |
| 8 | 1.0 mil | 1.5 mil | 16.48 |
| 9 | 1.0 mil | 1.5 mil | 16.05 |
| 10 | 1.0 mil | 1.5 mil | 14.64 |
| ave 6-10 | | | 15.70 |
| 11 | 1.5 mil | 1.0 mil | 16.04 |
| 12 | 1.5 mil | 1.0 mil | 16.39 |
| 13 | 1.5 mil | 1.0 mil | 17.39 |
| 14 | 1.5 mil | 1.0 mil | 17.12 |
| 15 | 1.5 mil | 1.0 mil | 14.27 |
| ave 11-15 | | | 16.24 |
| 16 | 1.0 mil | 1.0 mil | 16.23 |
| 17 | 1.0 mil | 1.0 mil | 16.40 |
| 18 | 1.0 mil | 1.0 mil | 17.37 |
| 19 | 1.0 mil | 1.0 mil | 17.17 |
| 20 | 1.0 mil | 1.0 mil | 14.30 |
| ave 16-20 | | | 16.29 |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A blister pack comprising:
(a) a contact adhesive that comprises (i) a metallocene-catalyzed olefin block copolymer; (ii) a mixture of polyethylene wax and Fischer-Tropsch wax, having a penetration hardness value of less than about 5 dmm at 25° C., measured in accordance with ASTM D3954; (iii) a plasticizer; and (iv) a tackifier;
(b) a paperboard substrate having a first substrate and a second substrate, and the contact adhesive is applied on the first surface;
(c) a paper substrate having a first substrate and a second substrate, and the contact adhesive is applied on the second surface; and
(d) an article;
wherein the article is sandwiched and adhered in between the applied contact adhesive of the first surface of the paperboard substrate and the applied contact adhesive of the second surface of the paper substrate.

2. The blister package of claim 1, wherein the contact adhesive is essentially free from polypropylene based polymer and/or wax.

3. The blister package of claim 1, wherein the metallocene-catalyzed olefin block copolymer which is an ethylene-octene block copolymer.

4. The blister package of claim 1, wherein the polyethylene wax and/or Fischer-Tropsch wax have a hardness value of less than or equal to about 3 dmm at measured in accordance with ASTM D1321.

5. The blister package of claim 1, further comprising an additive selected from the group consisting of antioxidant, brighteners, fillers, adhesion promoters, pigments and mixtures thereof.

6. The blister package of claim 1, wherein the paperboard substrate is selected from the group consisting of boxboard, chipboard or Kraft board, corrugated board, linerboard, and medium.

7. The blister package of claim 1, wherein the paper substrate has a thickness of about of about 0.008″ (8 point) to about 0.024″ (24 point).

8. A blister package comprising:
(a) a first substrate having a pre-applied contact adhesive on one surface;
(b) a second having the same contact adhesive pre-applied on one surface; and
(c) an article,
wherein the article is sandwiched and adhered in between the pre-applied contact adhesive of the first substrate and the pre-applied contact adhesive of the second substrate.

9. The blister package of claim 8,
wherein the first substrate is selected from the group consisting of boxboard, chipboard or Kraft board, corrugated board, linerboard, and medium; and
wherein the second substrate is a mixture of plastic film, foil, paper, and Kraft paper.

10. The blister package of claim 8,
wherein the pre-applied contact adhesive comprises (i) a metallocene-catalyzed olefin block copolymer; (ii) a mixture of polyethylene wax and Fischer-Tropsch wax, having a penetration hardness value of less than about 5 dmm at 25° C., measured in accordance with ASTM D3954; (iii) a plasticizer; and (iv) a tackifier

11. A method of forming an environmentally friendly blister package comprising:
(1) preparing a paperboard substrate having a first surface and a second surface, wherein a contact adhesive is applied onto the first surface of the paperboard substrate;
(2) preparing a paper substrate having a first surface and a second surface, wherein a contact adhesive is applied onto the second surface of the paper substrate;
(3) placing an article onto the first surface of the paperboard;
(4) applying the applied contact adhesive of the second surface of the paper surface on the applied contact adhesive of the first surface of the paperboard;
whereby the article is secured between the second surface of the paper and the first surface of the paperboard.

12. The method of forming the environmentally friendly blister package of claim 11, wherein the paperboard substrate is selected from the group consisting of boxboard, chipboard or Kraft board, corrugated board, linerboard, and medium.

13. The method of forming the environmentally friendly blister package of claim 11, wherein the paper substrate has a thickness of about of about 0.008″ (8 point) to about 0.024″ (24 point).

14. The method of forming the environmentally friendly blister package of claim 11, wherein the contact adhesive comprises (i) an ethylene-octene block copolymer; (ii) a mixture of polyethylene wax and Fischer-Tropsch wax, having a penetration hardness value of less than about 5 dmm at 25° C., measured in accordance with ASTM D3954; (iii) a plasticizer; and (iv) a tackifier.

15. The method of forming the environmentally friendly blister package of claim 11, wherein the contact adhesive is essentially free from polypropylene based polymer and/or wax.
